(19) United States
(12) Patent Application Publication
(10) Pub. No.: US 2019/0225037 A1
(43) Pub. Date: Jul. 25, 2019

(54) TOWING DEVICE FOR TRAILER OF VEHICLE

(71) Applicant: Jin Ho KANG, Daegu (KR)

(72) Inventor: Jin Ho KANG, Daegu (KR)

(21) Appl. No.: 16/121,108

(22) Filed: Sep. 4, 2018

(30) Foreign Application Priority Data
Jan. 25, 2018 (KR) 10-2018-0009068

(51) Int. Cl. B60D 1/24; B60D 1/52

(52) U.S. Cl. CPC B60D 1/24; B60D 1/52

(57) ABSTRACT

A towing device for a trailer of a vehicle includes: a connector including a fixing pipe of a rectangular pipe shape formed at a lower vehicle frame of the rear part of the vehicle, an expanded fixing pipe of a rectangular pipe shape, and a fitting recess formed in at least one among four sides of the expanded fixing pipe to be opened toward the rear part; and a hitch mount connected to the rear side of the connector to fix the trailer, the hitch mount including a mount frame of the rectangular pipe shape inserted and combined into the fixing pipe, an inclined mount guard formed at a rear end portion of the mount frame, a horizontal mount guard, a fitting protrusion, and a coupling pipe formed at a rear side of the mount frame to communicate.

### CROSS REFERENCE

This application claims foreign priority under Paris Convention to Korean Patent Application No. 10-2018-0009068, filed 25 Jan. 2018, with the Korean Intellectual Property Office, entirety of which is incorporated herein by reference.

### BACKGROUND

The present invention relates to a towing device for a trailer of a vehicle, and, more particularly, to a towing device for a trailer of a vehicle, which can relieve shock generated between the vehicle and the trailer due to a strong load by movement and vibration of the vehicle and the trailer when various trailers are connected and used to the vehicle.

In general, a towing device for a trailer of a vehicle is to connect various trailers manufactured for leisure activities and cargo transportation to a rear vehicle frame of the vehicle to carry goods to a destination in safety. The towing device makes a user carry not only small-sized goods but also large-sized heavy goods conveniently by tractive force of a vehicle, so has been widely used in real life.

Such a towing device has a structure that a steel frame having a coupler of a ball shape, a hook shape, a ring shape, or a pin shape is mounted at the rear of the vehicle by welding or bolt-coupling.

With respect to the above-mentioned technology, Korean Utility Model Registration No. 20-0439538 discloses a traction device for a trailer including: a plurality of coupling holes formed in an upper portion to be coupled to a vehicle frame of a lower end of a vehicle; a coupling plate having a plurality of coupling holes and is fixed and coupled to the inner face of a front side by a bolt and a nut; side frames formed on one side of the front face to be opposed to each other and having guide holes; coupling members having a plurality of coupling holes at lower ends thereof and fixed at the central portion of a side bar, which is inserted and guided into a guide hole perforated in one side of the front side of the side frame, to be spaced apart from each other at a predetermined interval and to be opposite to each other in the form of a ‘⊏’ shape; and a traction member interposed and coupled between the coupling members symmetric with each other, wherein the side bar inserted into one side of the side frames formed to be opposite to each other is coupled to the coupling plate by a U-bolt.

Moreover, Korean Patent No. 10-0835599 discloses a separable traction apparatus including: a main body; a traction ring part combined with the front of the main body by a coupling pin; a coupling hand grip part formed on the side surface of the main body to assemble and disassemble the main body to and from a coupling member of the traction apparatus by rotating a fastening pin; and the coupling member of the traction apparatus having a coupling hole to correspond to the fastening pin of the coupling hand grip part and combined with the rear of the main body.

For instance, because the conventional traction device is fixed and mounted at both sides of the rear vehicle frame of the vehicle, the traction device is fixed to two points of the vehicle frame. So, when the traction device tows a trailer on which heavy goods are loaded, because a strong impact by an uneven road surface or movement of the vehicle is intensively transferred to the two fixing points of the vehicle frame through the traction device, the vehicle frame may be distorted around the fixing points.

### SUMMARY OF THE INVENTION

Accordingly, the present invention has been made to solve the above-mentioned problems occurring in the prior arts, and it is an object of the present invention to provide a towing device for a trailer of a vehicle, which can relieve shock generated between the vehicle and the trailer due to a strong load by movement and vibration of the vehicle and the trailer when various trailers are connected and used to the vehicle.

To accomplish the above object, according to the present invention, there is provided a towing device for a trailer of a vehicle to connect the trailer to a rear part of the vehicle, the towing device comprising: a connector including a fixing pipe of a rectangular pipe shape formed at a lower vehicle frame of the rear part of the vehicle, an expanded fixing pipe of a rectangular pipe shape surrounding the outer surface of an end portion of the fixing pipe while getting in contact with the fixing pipe, and a fitting recess formed in at least one among four sides of the expanded fixing pipe to be opened toward the rear part; and a hitch mount connected to the rear side of the connector to fix the trailer, the hitch mount including a mount frame of the rectangular pipe shape inserted and combined into the fixing pipe, an inclined mount guard formed at a rear end portion of the mount frame to face the outside while getting upwards, a horizontal mount guard extending at an upper end portion of the inclined mount guard and having a hole at the rear portion, a fitting protrusion protrudingly formed on at least one among the four sides of the mount frame corresponding to the fitting recess of the connector to be inserted into the fitting recess, and a coupling pipe formed at a rear side of the mount frame to communicate, wherein in order to fix the connector and the hitch mount in the state that the hitch mount is inserted into the connector so that the fitting protrusion is inserted and fit into the fitting recess, the hitch mount has a long pin hole, the connector has a round pin hole to communicate with the pin hole, a long pin hole is formed to correspond to the pin holes, a connection body pipe having a nut at a rear end portion is located inside the hitch mount inserted into the connector, and a bolt is combined with the outer face of the coupling pipe of the hitch mount to be combined with the nut to adjust the position of the connection body pipe, and wherein after the pin holes coincide with each other, the bolt is rotated so as to back the connection body pipe having the nut rearwards in the state that the fixing pin penetrates through the pin holes, so that the connector, the hitch mount, and the connection body pipe are fixed and integrated by the fixing pin.

In this instance, the fitting recess are formed at an upper portion and a lower portion of the expanded fixing pipe so that the expanded fixing pipe can be applied regardless of the insertion direction of the hitch mount 30 according to the size of the trailer.

Moreover, the connection body pipe includes a rectangular slider plate formed at an end portion opposed to the nut of the connection body pipe 50 so as to be inserted into the rectangular mount frame and cause friction against the inner surface of the mount frame.

Furthermore, a concave groove is formed in at least one among four sides of the slide plate, and a protrusion rail is longitudinally formed on the inner surface of the mount frame corresponding to the concave groove, so that the slider plate is guided in the longitudinal direction to the inner surface of the mount frame in a state that the concave groove is fit to the protrusion rail.

Additionally, the fitting recess and the fitting protrusion are formed in a trapezoid shape, which gets narrower in the direction that the fitting protrusion is inserted into the fitting recess, and has both inclined surfaces.

In addition, the fitting protrusion has a detachable structure to adjust a distance between the fitting recess and the fitting protrusion in order to regulate the degree of friction between the fitting recess and the fitting protrusion.

Moreover, the fitting protrusion has an elongated hole portion perforated vertically, a bolt is disposed to be inserted downwardly from the upper portion of the elongated hole portion, and a plurality of through holes are formed in the upper surface of the mount frame, so that the bolt is inserted into the elongated hole portion to be fixed at the upper portion of the mount frame.

Furthermore, the fitting protrusion is formed in a trapezoid shape, which gets narrower in the direction that one end portion of the fitting protrusion is inserted into the fitting recess, to have both inclined surfaces, and if the trapezoid shape is formed such that both end portions of the fitting protrusion are symmetric with each other, when the end portion of the fitting protrusion causing friction while being inserted into the fitting recess, the fitting protrusion is turned so that the other end portion is inserted into the fitting recess.

According to the present invention, the towing device for a trailer of a vehicle can relieve shock generated between the vehicle and the trailer due to a strong load by movement and vibration of the vehicle and the trailer when various trailers are connected and used to the vehicle.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a towing device for a trailer of a vehicle according to the present invention;

FIG. 2 is a perspective view showing a part of the towing device for a trailer of a vehicle of FIG. 1;

FIG. 3 is a perspective view showing the towing device for a trailer of a vehicle of FIG. 1;

FIG. 4 is an exemplary view of an expanded fixing pipe of the towing device for a trailer of a vehicle;

FIG. 5 is a perspective view showing a state that a slider plate is moved inside a mount frame of the towing device for a trailer of a vehicle;

FIGS. 6 and 7 are views showing various examples of a state that a fitting protrusion is inserted into a fitting recess;

FIG. 8 is a perspective view of FIG. 7;

FIG. 9 is a perspective view of a detachable fitting protrusion according to another embodiment of the present invention;

FIG. 10 is a view showing another embodiment of FIG. 9;

FIG. 11 is a view showing a combined state of a connector and a hitch mount; and

FIG. 12 is a view showing another embodiment of the present invention.

### DETAILED DESCRIPTION OF THE PREFERRED EMBODIMENT

Hereinafter, exemplary embodiments of the present invention will be described in detail with reference to the accompanying drawings.

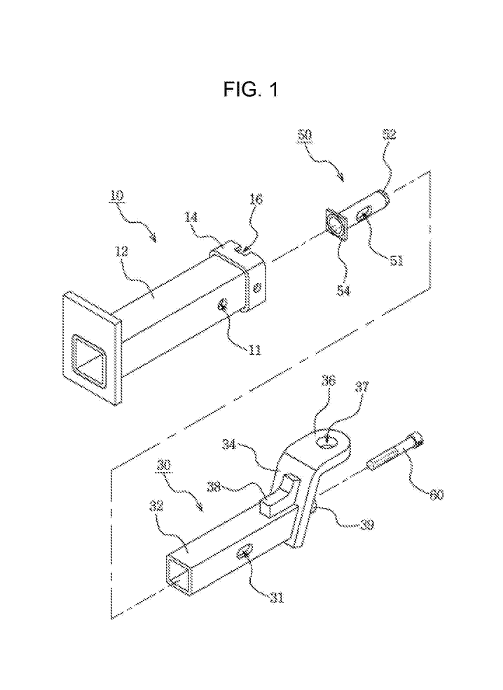

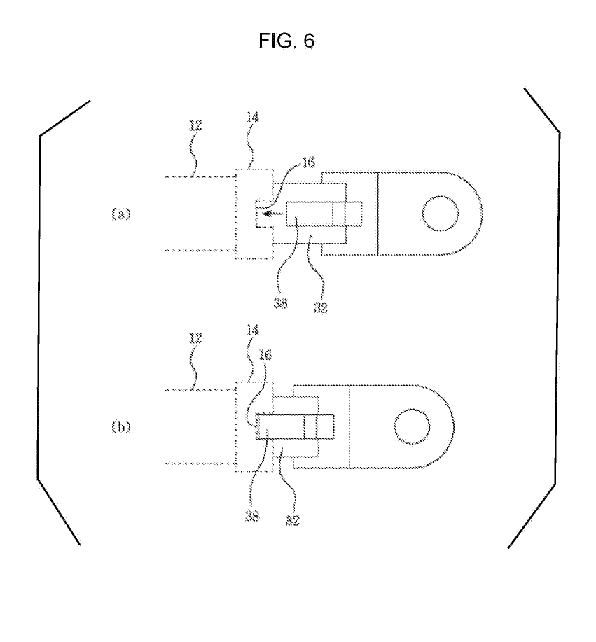

The present invention relates to a towing device for a trailer of a vehicle can relieve shock generated between the vehicle and the trailer due to a strong load by movement and vibration of the vehicle and the trailer when various trailers are connected and used to the vehicle. Referring to FIGS. 1 to 12, the towing device for a trailer of a vehicle includes a connector 10, a hitch mount 30, a connection body pipe 50, and a bolt 60.

As shown in FIG. 11, the present invention relates to the towing device for connecting a trailer 5 to a rear part of a vehicle 1. As shown in FIG. 1, the connector 10 includes: a fixing pipe 12 of a rectangular pipe shape formed at a lower vehicle frame of the rear part of the vehicle 1; an expanded fixing pipe 14 of a rectangular pipe shape surrounding the outer surface of an end portion of the fixing pipe 12 while getting in contact with the fixing pipe 12; and a fitting recess 16 formed at one or more sides among four sides of the expanded fixing pipe 14 to be opened toward the rear part.

It is preferable that the fixing pipe 12 be formed in the rectangular pipe shape in order to prevent vibration when the mount frame 32 of the corresponding hitch mount 30 is inserted into the fixing pipe 12, and in this instance, the fixing pipe 12 may be formed in one among various shapes, such as a hexagonal shape, an octagonal shape, and so on.

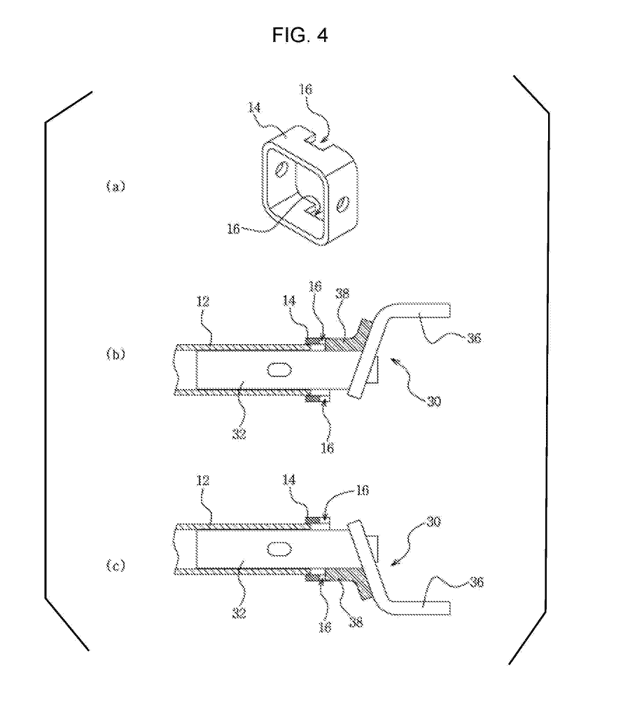

Moreover, it is preferable that the expanded fixing pipe 14 be welded and fixed in a state that a part of the expanded fixing pipe 14 is inserted into an end portion of the fixing pipe 12. When the fitting recess 16 is formed in the expanded fixing pipe 14, because an end portion of the expanded fixing pipe 14 and an end portion of the fixing pipe 12 coincide with each other and the fitting recesses 16 must be formed at the end portion of the expanded fixing pipe 14 and the end portion of the fixing pipe 12, it lowers workability. Therefore, as shown in FIGS. 4(B) and 4(C), in consideration of workability, the fitting recess 16 is formed only at the expanded fixing pipe 14.

In this instance, the fitting recess 16 is formed at one or more sides among the four sides of the expanded fixing pipe 14, and is formed to be opened in the rearward direction of the expanded fixing pipe 14 so that a front side of a fitting protrusion 38, which will be described later, is inserted into the fitting recess 16 to face each other.

As described above, the fitting recess 16 is formed at one or more sides among the four sides of the expanded fixing pipe 14, and in this instance, as shown in FIG. 4(A), fitting recesses 16 may be formed at upper and lower portions of the expanded fixing pipe 14. As shown in FIG. 4(B), a horizontal mount guard 36 of the hitch mount 30 may be located at an upper portion as shown in FIG. 4(B) or at a lower portion as shown in FIG. 4(C) according to the size of the trailer 5. That is, an insertion direction of the hitch mount 30 may be changed vertically. Therefore, the fitting recesses 16 are formed at the upper and lower portions of the expanded fixing pipe 14 so that the expanded fixing pipe can be applied regardless of the insertion direction of the hitch mount 30 according to the size of the trailer 5.

As shown in FIGS. 1 and 11, the hitch mount 30 operated by being inserted into the connector 10 is connected to the rear side of the connector 10 to fix the trailer 5. The mount frame 32 of the rectangular pipe shape inserted and combined into the fixing pipe 12 is formed, an inclined mount guard 34 is formed at a rear end portion of the mount frame 32 to face the outside while getting upwards, and the horizontal mount guard 36 having a hole 37 at the rear portion is extended at an upper end portion of the inclined mount guard 34.

The mount frame 32 is inserted into the fixing pipe 12 in the same rectangular shape as the fixing pipe 12, and the inclined mount guard 34 is formed to sufficiently secure an interval between the vehicle 1 and the trailer 5.

Furthermore, the horizontal mount guard 36 is to connect the trailer 5, and as shown in FIGS. 1 and 11, has the hole 37 to insert a ball connection member 97 for connection with the trailer 5.

In the meantime, the fitting protrusion 38 fit into the fitting recess 16 is protrudingly formed on at least one among the four sides of the mount frame 32 corresponding to the fitting recess 16 of the connector 10, and a coupling pipe 39 is formed at a rear side of the mount frame 32 to communicate.

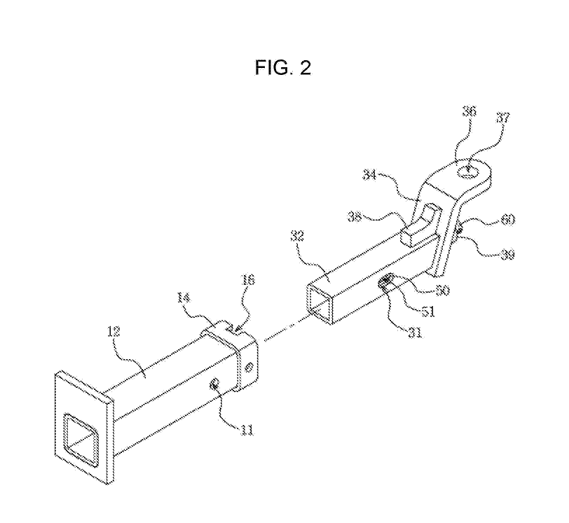

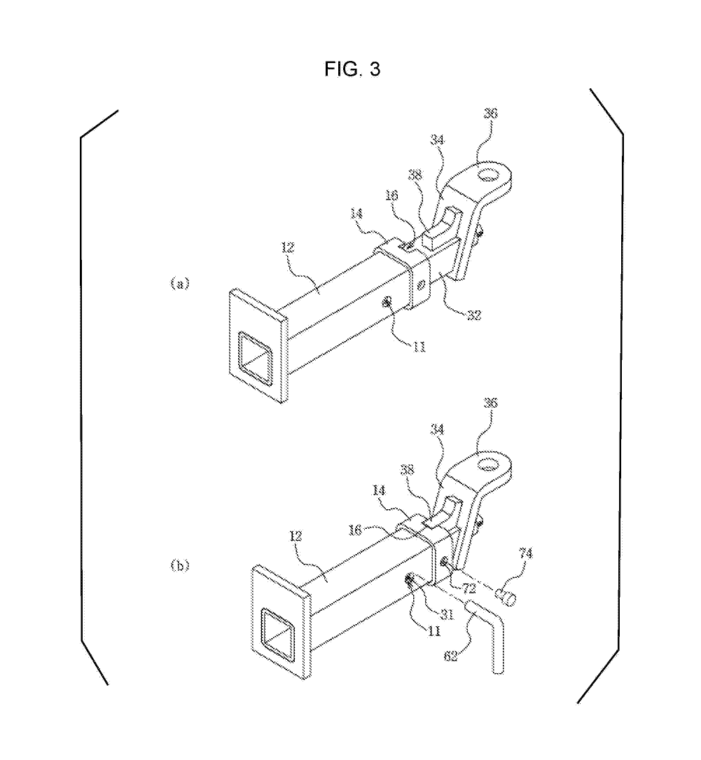

In order to fix the connector 10 and the hitch mount 30 in the state that the hitch mount 30 is inserted into the connector 10 so that the fitting protrusion 38 is inserted and fit into the fitting recess 16, as shown in FIGS. 1 and 2, the hitch mount 30 has a long pin hole 31, and the connector 10 has a round pin hole 11 to communicate with the pin hole 31. A long pin hole 51 is formed to correspond to the pin holes 11 and 31. Additionally, the connection body pipe 50 having a nut 52 at a rear end portion is located inside the hitch mount 30 inserted into the connector 10, and a bolt 60 is combined with the outer face of the coupling pipe 39 of the hitch mount 30 to be combined with the nut 52 to adjust the position of the connection body pipe 50. So, as shown in FIG. 3(B), after the pin holes 11, 31 and 51 coincide with each other, the bolt 60 is rotated so as to back the connection body pipe 50 having the nut 52 rearwards in the state that the fixing pin 62 penetrates through the pin holes 11, 31 and 51, so that the connector 10, the hitch mount 30, and the connection body pipe 50 are fixed and integrated by the fixing pin 62.

In this instance, in order to fix more securely, as shown in FIG. 3(B), at least one female screw hole 72 is formed in one side or in both symmetric sides of the expanded fixing pipe 14, and a bolt 74 is coupled to the female screw hole 72, so that the mount frame 32 of the hitch mount 30 located inside the expanded fixing pipe 14 is fixed by the bolt 74.

If the hitch mount 30 is fixed to the connector 10 through the coupling of the fitting recess 16 and the fitting protrusion 38, when various trailers 5 are connected to the vehicle to be used, it can relieve impact generated between the connector 10 and the hitch mount 30 due to the strong load according to movement and vibration of the vehicle and the trailer 5.

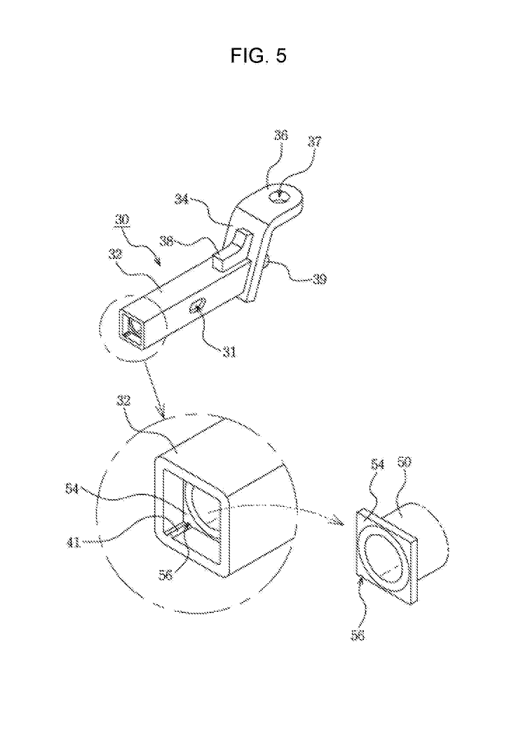

As another embodiment to relieve such vibration and impact more, as shown in FIG. 5, the connection body pipe 50 includes a rectangular slider plate 54 formed at an end portion opposed to the nut 52 so as to be inserted into the rectangular mount frame 32 and cause friction against the inner surface of the mount frame 32. In this instance, a concave groove 56 is formed in at least one among four sides of the slide plate 54, and a protrusion rail 41 is longitudinally formed on the inner surface of the mount frame 32 corresponding to the concave groove 56, so that the slider plate 54 is guided in the longitudinal direction to the inner surface of the mount frame 32 in a state that the concave groove 56 is fit to the protrusion rail 41. Therefore, it prevents vibration of the connection body pipe 50, which slides inside the mount frame 32 of the hitch mount 30.

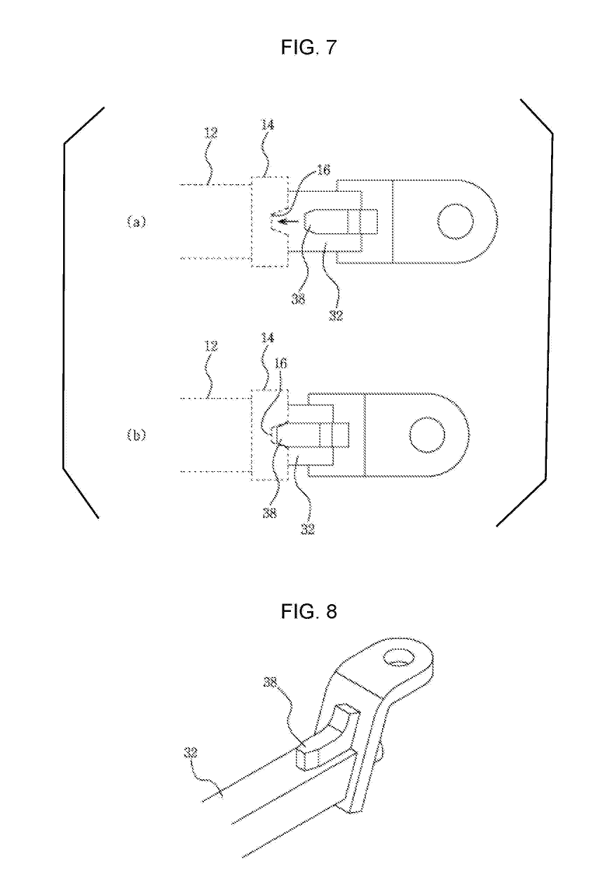

As a further embodiment, as shown in FIGS. 7 and 8, the fitting recess 16 and the fitting protrusion 38 may be formed in a trapezoid shape, which gets narrower in the direction that the fitting protrusion 38 is inserted into the fitting recess 16, and has both inclined surfaces 92. In the above structure, if the fitting protrusion 38 is inserted into the fitting recess 16, in comparison with a rectangular shape, because both end portions of the front part of the fitting protrusion 38 is stopped by friction force while being inserted into the fitting recess 16, namely, because an interval space between the fitting recess 16 and the fitting protrusion 38 gets narrower, the trapezoidal shape can firmly prevent vibration.

In addition, as shown in FIG. 12, a friction pad 98 is disposed at any one among the surfaces of the fitting recess 16 and the fitting protrusion 38, which come in close contact with each other, to reduce shock by vibration, so the present invention can maximize the effect to reduce shock by vibration.

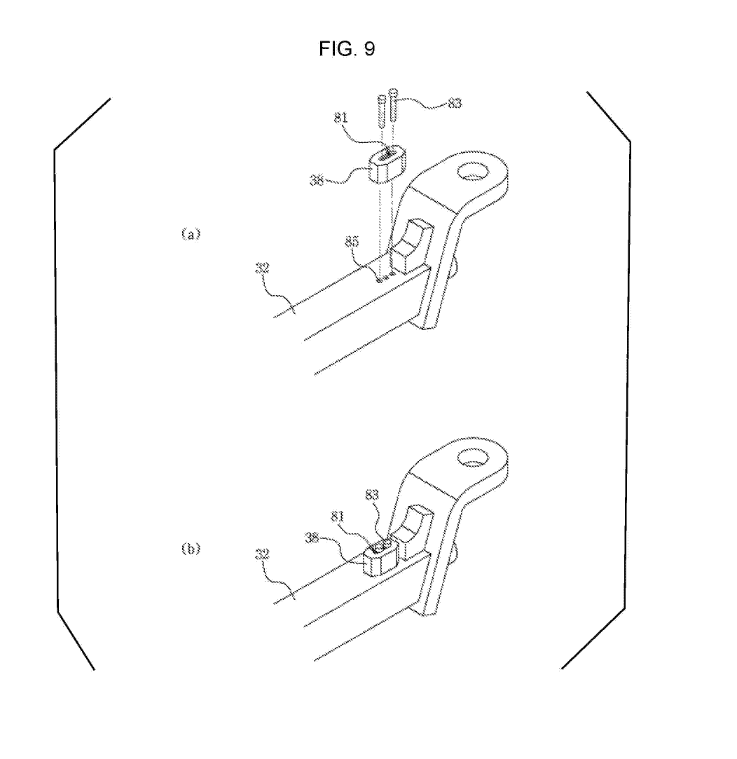

As another embodiment of the fitting protrusion 38, as shown in FIG. 9, the fitting protrusion 38 may have a detachable structure. In this instance, the fitting protrusion 38 has an elongated hole portion 81 perforated vertically, a bolt 83 is disposed to be inserted downwardly from the upper portion of the elongated hole portion 81, and a plurality of through holes 85 are formed in the upper surface of the mount frame 32 so that the bolt 83 is inserted into the elongated hole portion 81 to be fixed at the upper portion of the mount frame 32. Therefore, the fitting protrusion 38 can be adjusted in its position.

In this instance, the elongated hole portion 81 is formed in the movement direction of the hitch mount 30, and the plurality of through holes 85 are formed to correspond to the elongated hole portion 81.

The fitting protrusion 38 is adjustable in its position due to the elongated hole portion 81 and the plurality of through holes 85, that is, is adjustable in its distance. So, because the degree of friction between the fitting recess 16 and the fitting protrusion 38 inserted and fit into the fitting recess 16 is regulated, that is, because the length of the fitting protrusion 38 is extended to come into contact with the fitting recess 16 and cause friction against the fitting recess 16 when the degree of friction is insufficient, it can increase contact force between the fitting recess 16 and the fitting protrusion 38. Therefore, the present invention can relieve vibration and shock.

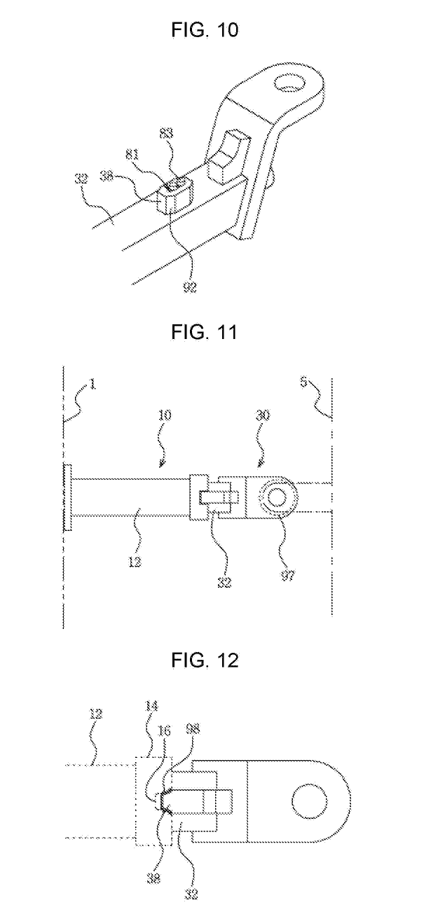

Moreover, as shown in FIG. 10, if the fitting protrusion 38 is moved further away in the forward direction from the position of FIG. 9, a distance between the connector 10 and the hitch mount 30 gets longer.

In the meantime, as shown in FIGS. 9 and 10, the fitting protrusion 38 is formed in a trapezoid shape, which gets narrower in the direction that one end portion of the fitting protrusion 38 is inserted into the fitting recess 16, to have both inclined surfaces 92. If the trapezoid shape is formed such that both end portions of the fitting protrusion 38 are symmetric with each other, when the end portion of the fitting protrusion 38 causing friction while being inserted into the fitting recess 16, the fitting protrusion 38 is turned so that the other end portion is inserted into the fitting recess 38. So, the present invention can sufficiently secure an available period.

According to the present invention, the towing device for a trailer of a vehicle can relieve shock generated between the vehicle and the trailer due to a strong load by movement and vibration of the vehicle and the trailer when various trailers are connected and used to the vehicle.

As described above, while the present invention has been particularly shown and described with reference to the example embodiments thereof, it will be understood by those of ordinary skill in the art that the above embodiments of the present invention are all exemplified and various changes, modifications and equivalents may be made therein without changing the essential characteristics and scope of the present invention. Therefore, it would be understood that the technical and protective scope of the present invention is interpreted by the following claims and all technical ideas within the equivalent scope belong to the technical scope of the present invention.

What is claimed is:

1. A towing device for a trailer of a vehicle to connect the trailer to a rear part of the vehicle, the towing device comprising:
a connector including a fixing pipe of a rectangular pipe shape formed at a lower vehicle frame of the rear part of the vehicle, an expanded fixing pipe of a rectangular pipe shape surrounding the outer surface of an end portion of the fixing pipe while getting in contact with the fixing pipe, and a fitting recess formed in at least one among four sides of the expanded fixing pipe to be opened toward the rear part; and
a hitch mount connected to the rear side of the connector to fix the trailer, the hitch mount including a mount frame of the rectangular pipe shape inserted and combined into the fixing pipe, an inclined mount guard formed at a rear end portion of the mount frame to face the outside while getting upwards, a horizontal mount guard extending at an upper end portion of the inclined mount guard and having a hole at the rear portion, a fitting protrusion protrudingly formed on at least one among the four sides of the mount frame corresponding to the fitting recess of the connector to be inserted into the fitting recess, and a coupling pipe formed at a rear side of the mount frame to communicate,
wherein in order to fix the connector and the hitch mount in the state that the hitch mount is inserted into the connector so that the fitting protrusion is inserted and fit into the fitting recess, the hitch mount has a long pin hole, the connector has a round pin hole to communicate with the pin hole, a long pin hole is formed to correspond to the pin holes, a connection body pipe having a nut at a rear end portion is located inside the hitch mount inserted into the connector, and a bolt is combined with the outer face of the coupling pipe of the hitch mount to be combined with the nut to adjust the position of the connection body pipe, and
wherein after the pin holes coincide with each other, the bolt is rotated so as to back the connection body pipe having the nut rearwards in the state that the fixing pin penetrates through the pin holes, so that the connector, the hitch mount, and the connection body pipe are fixed and integrated by the fixing pin.

2. The towing device according to claim 1, wherein the fitting recess are formed at an upper portion and a lower portion of the expanded fixing pipe so that the expanded fixing pipe can be applied regardless of the insertion direction of the hitch mount 30 according to the size of the trailer.

3. The towing device according to claim 1, wherein the connection body pipe includes a rectangular slider plate formed at an end portion opposed to the nut of the connection body pipe 50 so as to be inserted into the rectangular mount frame and cause friction against the inner surface of the mount frame.

4. The towing device according to claim 3, wherein a concave groove is formed in at least one among four sides of the slide plate, and a protrusion rail is longitudinally formed on the inner surface of the mount frame corresponding to the concave groove, so that the slider plate is guided in the longitudinal direction to the inner surface of the mount frame in a state that the concave groove is fit to the protrusion rail.

5. The towing device according to claim 3, wherein the fitting recess and the fitting protrusion are formed in a trapezoid shape, which gets narrower in the direction that the fitting protrusion is inserted into the fitting recess, and has both inclined surfaces.

6. The towing device according to claim 5, wherein the fitting protrusion has a detachable structure to adjust a distance between the fitting recess and the fitting protrusion in order to regulate the degree of friction between the fitting recess and the fitting protrusion.

7. The towing device according to claim 6, wherein the fitting protrusion has an elongated hole portion perforated vertically, a bolt is disposed to be inserted downwardly from the upper portion of the elongated hole portion, and a plurality of through holes are formed in the upper surface of the mount frame, so that the bolt is inserted into the elongated hole portion to be fixed at the upper portion of the mount frame.

8. The towing device according to claim 7, wherein the fitting protrusion is formed in a trapezoid shape, which gets narrower in the direction that one end portion of the fitting protrusion is inserted into the fitting recess, to have both inclined surfaces, and if the trapezoid shape is formed such that both end portions of the fitting protrusion are symmetric with each other, when the end portion of the fitting protrusion causing friction while being inserted into the fitting recess, the fitting protrusion is turned so that the other end portion is inserted into the fitting recess.
